(19) United States
(12) Patent Application Publication
(10) Pub. No.: US 2026/0149816 A1
(43) Pub. Date: May 28, 2026

(54) PARAMETERS INHERITANCE FOR SAMPLE OFFSETS

(71) Applicant: Tencent America LLC, Palo Alto, CA (US)

(72) Inventors: Tianqi LIU, Palo Alto, CA (US); Liang ZHAO, Palo Alto, CA (US); Madhu PERINGASSERY KRISHNAN, Palo Alto, CA (US); Ting-Lan LIN, Palo Alto, CA (US); Jayasingam ADHURAN, Palo Alto, CA (US); Shan LIU, Palo Alto, CA (US)

(21) Appl. No.: 19/366,484

(22) Filed: Oct. 22, 2025

Related U.S. Application Data
(60) Provisional application No. 63/725,507, filed on Nov. 26, 2024.

(51) Int. Cl. H04N 19/172; H04N 19/105; H04N 19/70

(52) U.S. Cl. CPC H04N 19/172; H04N 19/105; H04N 19/70

(57) ABSTRACT

An example method of video coding includes receiving a video bitstream comprising a plurality of frames, including a current frame, and identifying a primary reference frame used for a context initialization for the current frame. The method also includes identifying a reference frame for the current frame based on the primary reference frame, and reconstructing the current frame by applying a cross-component sample offset (CCSO) mode using the reference frame.

### PRIORITY AND RELATED APPLICATIONS

This application claims priority to U.S. Provisional Patent Application No. 63/725,507, entitled “Parameters Inheritance for Sample Offsets,” filed Nov. 26, 2024, which is hereby incorporated by reference in its entirety.

### TECHNICAL FIELD

The disclosed embodiments relate generally to video coding, including but not limited to systems and methods for loop filtering (e.g., cross-component offset filtering) of video data.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

As mentioned above, encoding (compression) reduces the bandwidth and/or storage space requirements. As described in detail later, both lossless compression and lossy compression can be employed. Lossless compression refers to techniques where an exact copy of the original signal can be reconstructed from the compressed original signal via a decoding process. Lossy compression refers to coding/decoding process where original video information is not fully retained during coding and not fully recoverable during decoding. When using lossy compression, the reconstructed signal may not be identical to the original signal, but the distortion between original and reconstructed signals is made small enough to render the reconstructed signal useful for the intended application. The amount of tolerable distortion depends on the application. For example, users of certain consumer video streaming applications may tolerate higher distortion than users of cinematic or television broadcasting applications. The compression ratio achievable by a particular coding algorithm can be selected or adjusted to reflect various distortion tolerance: higher tolerable distortion generally allows for coding algorithms that yield higher losses and higher compression ratios.

The present disclosure describes methods, systems, and non-transitory computer-readable storage media for applying a loop filter for video (image) compression. In-loop filtering technologies are applied to adjust reconstructed picture samples to further reduce a reconstruction error. Cross-component sample offset (CCSO) filtering may be implemented to apply a co-located reconstructed sample and associated neighboring reconstructed samples of a first color component to derive an offset value that is added on a current sample of a second color component, thereby adjusting a reconstruction value of the current sample. When a frame-level or block-level cross component sample offset syntax reuses the syntax from the reference frames, the reference frame index can be implicitly derived or explicitly signaled. The signaling of the reference frame index may depend on the primary reference frame or the derived primary reference frame used for frame context initialization. By selectively signaling the reference frame index based on the context's the primary reference frame, signaling overhead can be reduced and coding efficiency can be improved. In some approaches, when the reference frame index is signaled, it can be signaled for a reduced set and/or signaled for multiple color components so as to reduce/minimize signaling overhead for the coded video bitstream.

In accordance with some embodiments, a method of video decoding includes: (i) receiving a video bitstream comprising a plurality of frames, including a current frame; (ii) identifying a primary reference frame used for a context initialization for the current frame; (iii) identifying a reference frame for the current frame based on the primary reference frame; and (iv) reconstructing the current frame using the reference frame.

In accordance with some embodiments, a method of video encoding includes (i) receiving video data comprising a plurality of frames, including a current frame; (ii) identifying a primary reference frame used for a context initialization for the current frame; (iii) identifying a reference frame for the current frame based on the primary reference frame; and (iv) encoding the current frame using the reference frame.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder). In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates the computation of a prediction block in accordance with some embodiments.

FIG. 4B illustrates the computation of a residue block in accordance with some embodiments.

FIG. 4C illustrates the computation of a reconstructed block in accordance with some embodiments.

FIG. 5 illustrates example in-loop filtering stages in accordance with some embodiments.

FIG. 6A illustrates an example video decoding process in accordance with some embodiments.

FIG. 6B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes methods, systems, and non-transitory computer-readable storage media for applying a loop filter for video (image) compression. For example, a primary reference frame used for a context initialization for a current frame may be identified. A reference frame for the current frame may be identified based on the primary reference frame. The current frame may be reconstructed by applying a cross-component sample offset (CCSO) mode using the reference frame. Using the primary reference frame to identify the reference frame for the current frame saves signaling overhead as an index for the reference frame need not be signaled in some cases.

The present disclosure describes, amongst other things, techniques for CCSO filtering in video coding, specifically enabling syntax reuse from reference frames at either the frame or block level. Mechanisms are described herein for implicitly deriving or explicitly signaling the reference frame index based on the primary reference frame used for context initialization, as well as selectively signaling indices for a reduced set of reference frames. Additionally, techniques are described for reusing CCSO syntax flags across multiple color channels, such as Y, U, and V, or allowing separate signaling for the Y channel while U and V share flags. These approaches yield significant benefits, including reduced signaling overhead in the video bitstream, improved coding efficiency, and enhanced flexibility in syntax management. By leveraging context initialization and optimized reference frame selection, unnecessary signaling can be reduced/minimized, enabling more efficient video compression, which is particularly advantageous for bandwidth-constrained or storage-limited applications.

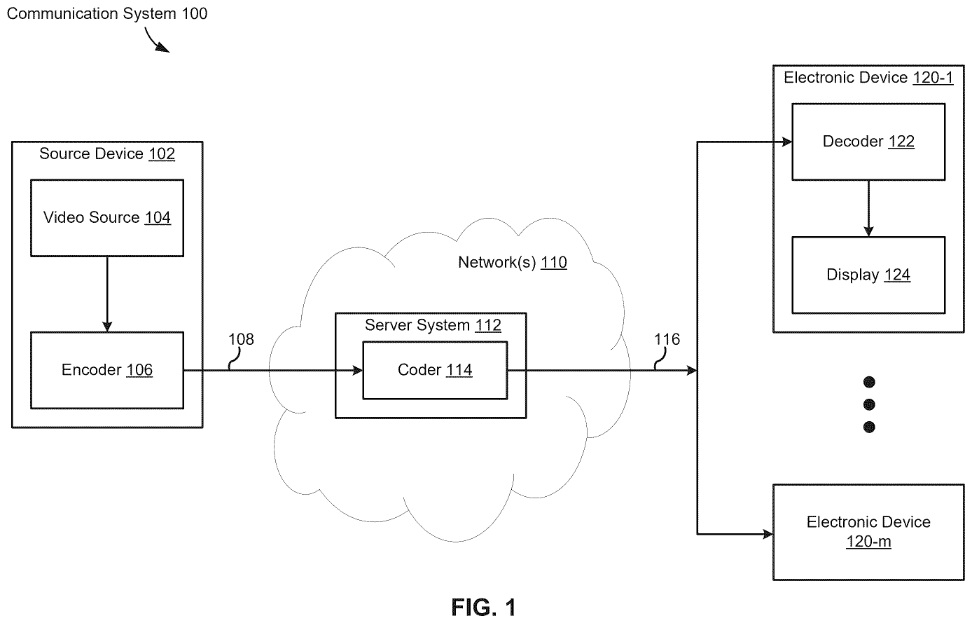

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

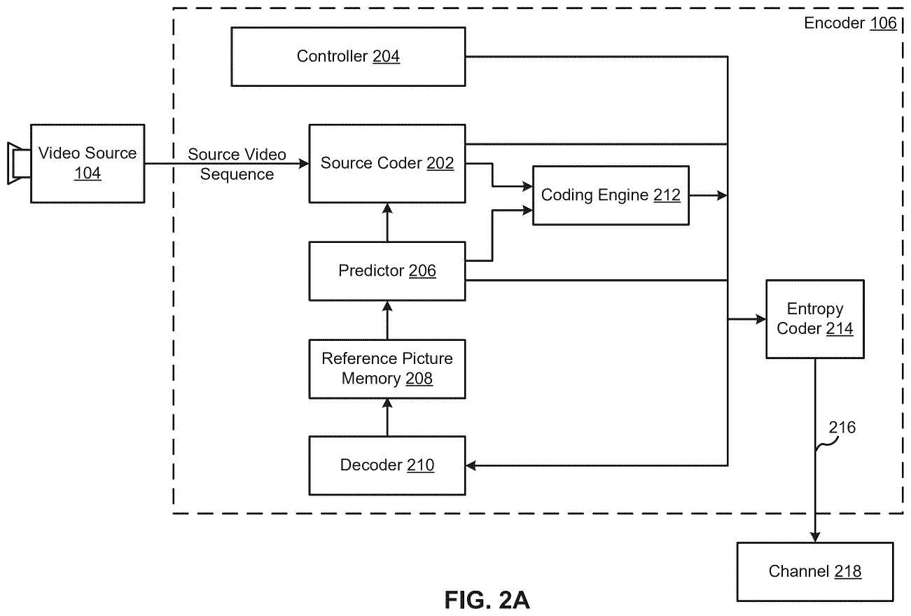

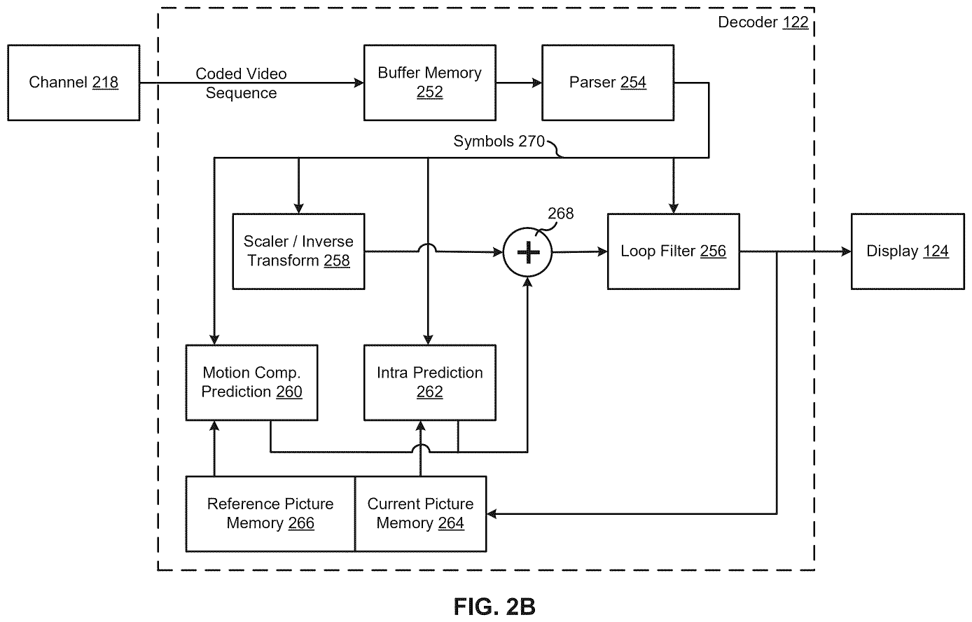

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding. This principle of reference picture synchronicity (and resulting drift, if synchronicity cannot be maintained, for example because of channel errors) is known to a person of ordinary skill in the art.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. The description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, for example, temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268.

In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation also can include interpolation of sample values as fetched from the reference picture memory 266 when sub-sample exact motion vectors are in use, motion vector prediction mechanisms, and so forth.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

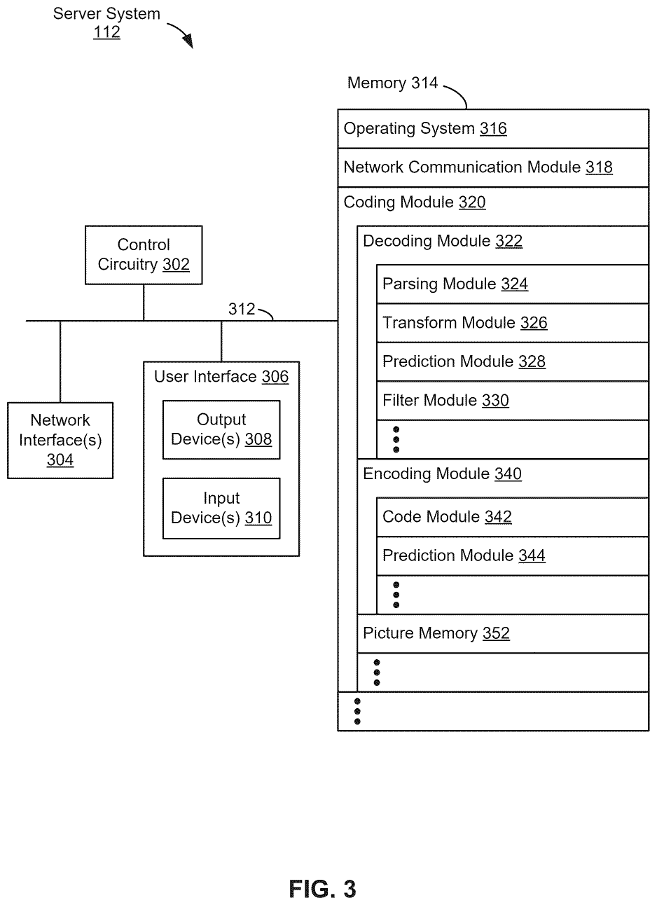

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes one or more field-programmable gate arrays (FPGAs), hardware accelerators, and/or one or more integrated circuits (e.g., an application-specific integrated circuit).

The network interface(s) 304 may be configured to interface with one or more communication networks (e.g., wireless, wireline, and/or optical networks). The user interface 306 includes one or more output devices 308 and/or one or more input devices 310. The input device(s) 310 may include one or more of: a keyboard, a mouse, a trackpad, a touch screen, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. Although FIG. 3 illustrates the server system 112 in accordance with some embodiments, FIG. 3 is intended more as a functional description of the various features that may be present in one or more server systems rather than a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

The coding processes and techniques described below may be performed at the devices and systems described above (e.g., the source device 102, the server system 112, and/or the electronic device 120). According to some embodiments, methods for loop filtering (e.g., cross-component offset filtering) are described.

Cross-Component Sample Offset (CCSO) is a filtering process using the co-located reconstructed sample and its neighboring reconstructed samples from a first color component as input, to derive an offset value that is added on the current sample of a second color component to adjust its reconstruction value. Examples of the first color component is luma color component, and examples of the second color component is chroma color component. The first color component and second color component can be the same color component, e.g., luma.

In some embodiments a three-step process is used to derive offset values: (1) calculating delta values using co-located and neighboring reconstructed samples from a first color component, (2) quantizing the delta values into edge classes using scalar quantizers with configurable intervals, and (3) determining offset values based on the edge classes using specialized LUTs. By incorporating these steps, the described systems achieve improved coding efficiency and visual quality. Furthermore, the system architecture supports the concurrent operation of CCSO filtering with other in-loop filters, such as deblocking and constrained directional enhancement filters, to enhance the overall effectiveness of the video coding pipeline. This approach not only improves the reconstructed video quality but also ensures compatibility with existing video coding standards, making the solution adaptable and practical for modern video compression systems.

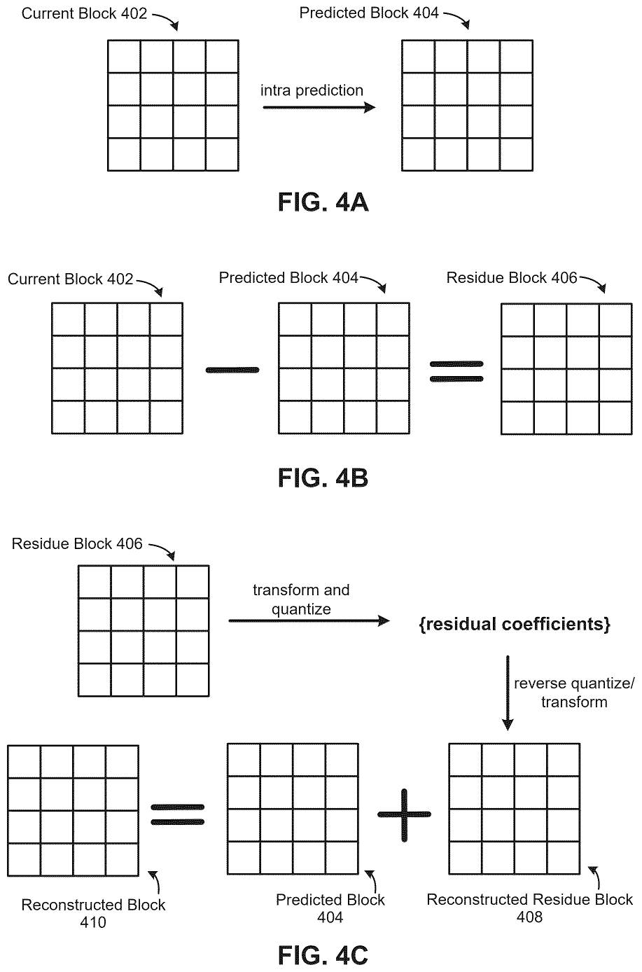

FIGS. 4A-4C illustrate an overview of a quantization and subsequent dequantization process. FIG. 4A illustrates the computation of a prediction block in accordance with some embodiments. In the example of FIG. 4A, an intra prediction is performed on a current block 402 to generate a predicted block 404. The current block 402 includes a set of samples (e.g., pixel blocks) and the prediction block 404 includes a set of predictions that correspond to the set of samples. FIG. 4B illustrates the computation of a residue block in accordance with some embodiments. As shown in FIG. 4B, the prediction block 404 is subtracted from the current block 402 to generate a residue block 406 that includes a set of residues. For example, respective differences are calculated between each sample and the corresponding prediction. FIG. 4C illustrates the computation of a reconstructed block in accordance with some embodiments. As shown in FIG. 4C, the residue block 406 undergoes one or more transformations and quantization to generate a set of residual coefficients. The set of residual coefficients may be transmitted from an encoder component to a decoder component. The set of residual coefficients undergo a reverse quantization and reverse transformation to generate a reconstructed residue block 408. The reconstructed residue block 408 is combined with the predicted block 404 (e.g., reconstructed residues of the reconstructed residue block 408 are added to predictions of the prediction block 404) to generate a reconstructed block 410 corresponding to the current block 402.

Notably, the transforms performed during decoding of the video bitstream may be inverses of the transformed performed during encoding of the video bitstream and are sometimes referred to as “inverse transforms”. For simplicity, the transformations described herein may be referred to as “transforms” whether performed during encoding or decoding.

In Constrained Directional Enhancement Filter (CDEF), edge detection is performed on each block (e.g., an 8×8 block) using predefined directional patterns. The CDEF algorithm analyzes the pixel values along eight possible directions and selects the direction that minimizes the sum of squared differences between pixels and their mean along that direction. Once the dominant edge direction is determined, CDEF applies a non-linear filter along the detected direction (primary filter) and a secondary filter oriented at 45 degrees to the primary direction. This directional filtering reduces ringing and other artifacts while preserving sharp edges, resulting in improved visual quality of the reconstructed video.

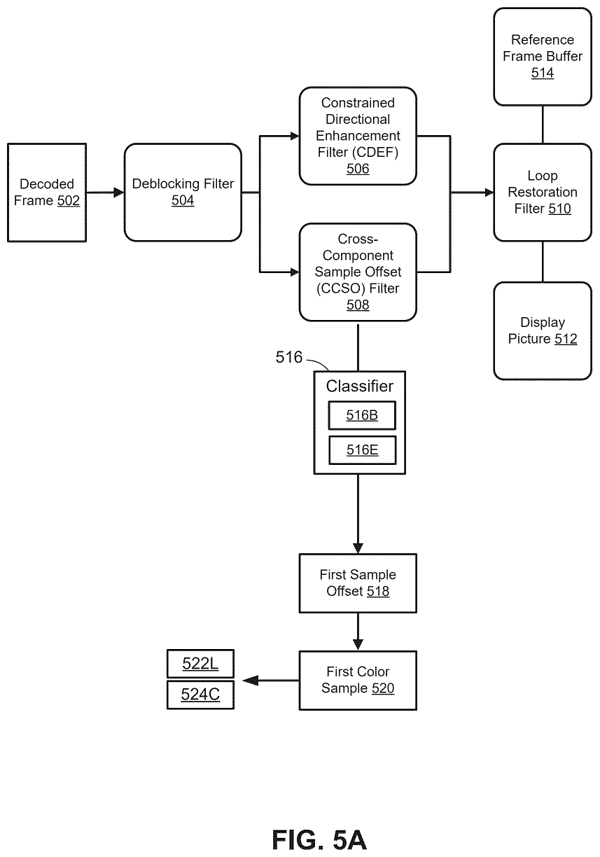

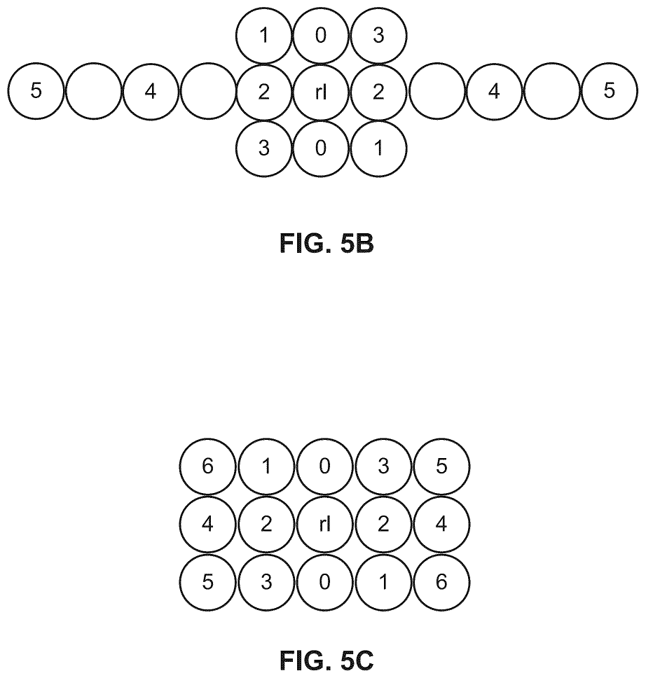

FIG. 5A illustrates example in-loop filtering stages in accordance with some embodiments. In the example of FIG. 5, the in-loop filtering stages applied to the decoded frame 502 include a deblocking filter 504, a CDEF 506, a CCSO filter 508 and a loop restoration filter 510. In some embodiments, the filtered output frame is used as a reference frame for later frames (e.g., stored in a reference frame buffer 514). In some embodiments, a normative film grain synthesis stage is also applied to generate a corresponding displayed picture 512. Unlike the in-loop filter stages, the results of the film grain synthesis stage (e.g., an out-of-loop filter) does not influence the prediction for subsequent frames. The loop filtering methods may include any filtering process applied on the reconstructed samples (e.g., after adding residual to the prediction), including wiener loop filtering, cross-component filtering via the CCSO filter 508 and the CDEF 506.

In some embodiments, a CCSO filtering method may use (e.g., by applying CCSO filter 508) a co-located reconstructed sample and neighboring reconstructed samples from a first color component as input, to perform filtering of the current reconstruction sample of a second color component. In some embodiments, a CCSO filtering method may use (e.g., by applying CCSO filter 508) the co-located reconstructed sample and its neighboring reconstructed samples from a first color component as input, to derive an offset value that is added on the current sample of a second color component to adjust its reconstruction value. The first color component may refer to a luma color component, and the second color component may refer to a chroma color component. The first color component and second color component may be the same color component (e.g., a luma component). The CCSO filter 508 may produce offset values, which are added to the reconstructed samples of the luma and chroma components to reduce reconstruction error. In some embodiments, the CCSO filter 508 operates concurrently with CDEF 506. For example, the reconstructed samples following deblocking 504 may be used as input for both the CDEF 506 and the CCSO filter 508.

The deblocking filter 504 may be applied across the transform block boundaries to remove block artifacts caused by the quantization error. In some embodiments, a filter length is determined based on the minimum transform block sizes on both sides. In some embodiments, finite impulse response (FIR) filters (e.g., low-pass filters) are used by the deblocking filter 504. Edge detection may be used to disable the deblocking filter at transitions that contain a high variance signal (e.g., to avoid blurring an actual edge in the original image). In this way, a deblocking filtering method may be applied on reconstructions samples located close to block boundaries. The block boundaries may include a transform block boundary, a motion compensation block boundary, a coding block boundary, and/or a fixed block size boundary.

The CDEF 506 applies a non-linear de-ringing filter along particular (e.g., oblique) directions. The CDEF 506 may operate on an output of the deblocking filter 504. The CDEF 506 may operate in 8×8 units. In some embodiments, 8 preset directions are defined by rotating and reflecting templates of preset directions. The decoder may use the reconstructed pixels to select the prevalent direction index. A primary filter may be applied along the selected direction, and a secondary filter may be applied along an offset direction (e.g., oriented 45° off the primary direction). In some embodiments, up to 8 groups of filter parameters are signaled (e.g., in a frame header). The groups of filter parameters may include the primary and secondary filter strength indexes of luma and chroma components. The CDEF may apply filtering on reconstruction samples by identifying the direction of each block and then adaptively filtering with a high degree of control over the filter strength along the direction and across it.

In some embodiments, the loop restoration filter 510 is applied to reconstructed pixels after any prior in-loop filtering stages (e.g., the deblocking filter 504, the CDEF 506, and/or CCSO filter 508). The loop restoration filter 510 may be applied to loop restoration units (LRU), e.g., 64×64, 128×128, and/or 256×256 pixel blocks. Bypass filtering, a wiener filter (e.g., a wiener loop filtering method), and/or a self-guided filter may be applied to each LRU independently. A wiener loop filtering method may use a linear weighted sum of the current reconstruction sample and multiple spatially neighboring reconstruction samples as input to derive a modified value for the current reconstruction sample as the output.

CCSO is designed for improved loop filtering on both luma and chroma components. In some embodiments, the filtering process of CCSO involves three main steps. First, the current reconstructed luma samples (e.g., the output of the deblocking process) are classified using classifiers 516. There are two types of classifiers: the edge-offset (EO) classifier 516E and the band-offset (BO) classifier 516B. These classifiers can operate jointly or individually based on indicators signaled at the frame level. Second, the class associated with the current luma sample is used as an index to fetch offset values from a lookup table (LUT), which is determined at the frame level with entries selected from a limited number of predefined values. This LUT is shared across the entire frame. Finally, the derived offset values using the LUT and class index are added to the corresponding luma and chroma components. A filter unit-level on/off flag (non-overlapped 256×256 luma samples) is signaled to indicate whether CCSO filtering is applied for the associated filter unit.

With continued reference to FIG. 5A, in some embodiments associated with band offset classification, the CCSO filtering method comprises a band offset classifier 516B. Based on the band offset classifier 516B, the decoder 122 may determine that a set of target luma samples includes a first luma sample and one or more neighboring luma samples. The set of target luma samples are provided to a quantizer, and used to generate one or more quantized values, which are further applied by the band offset classifier 516B to classify the first color sample 520. In some embodiments associated with edge offset classification, the CCSO filtering method comprises an edge offset classifier 516E. Based on the edge offset classifier 516E, the decoder 122 may determine that a set of target luma samples includes a first luma sample and one or more neighboring luma samples. Difference values of the neighboring luma samples and the first luma sample are provided to a quantizer, and used to generate one or more quantized values, which are further applied by the edge offset classifier 516E to classify the first color sample 520. In some embodiments, the first color sample 520 is classified, e.g., by the classifier 516, based on the quantized values to determine the first sample offset 518 of the first color sample 520. The first color sample 520 is adjusted based on the first sample offset 518 of the first color sample 520, thereby enabling reconstruction of the current image frame. In some embodiments, the first color sample 520 includes a first chroma sample 524C that is co-located with the first luma sample 522L in the current image frame, and the first chroma sample 524C is adjusted based on the first sample offset 518. Alternatively, in some embodiments, the first color sample 520 is the first luma sample 522L, and the first luma sample 524C is adjusted based on the first sample offset 518.

As described above, CCSO is an edge preserving loop filter that uses the reconstructed samples to compute the sample offsets of luma and/or chroma components. In some embodiments, only the luma samples located in positions defined by the filter shape are used to compute the offset of the chroma component or the luma component. In some embodiments, the offset value may be derived by three steps:
In the first step, values are derived using the co-located reconstructed sample and its neighboring reconstructed samples from a first color component. For example, one or multiple difference values between the co-located reconstructed sample and its neighboring reconstructed samples from a first color component. The positions of the neighboring reconstructed samples are selected based on a given filter shape (e.g., as shown in FIG. 5B). The filter shape index may be signaled in a frame header.
In the second step, the derived values are quantized using a scalar quantizer. A scalar quantizer is specified by quantization intervals and quantization levels, a quantization interval is defined to be the range of values assigned to the same integer, and a quantization level is defined as the integer value to which all values within a quantization interval are assigned.
In the third step, given the quantized derived values (or quantization level) as a classifier, an offset value may be derived based on the value of given classifier. For example, the combinations of quantized values are used as indices to a selected look-up table, and the output of the selected look-up table is the offset value.

As mentioned previously, CDEF uses a non-linear low-pass filter along edge directions. CDEF includes eight predefined directional patterns, with direction detection performed in each 8×8 block. Once the direction is determined, a weighted sum of neighboring samples is calculated to reduce ringing artifacts. CDEF employs two types of non-linear filters: the primary filter and the secondary filter. The primary filter applies taps along the detected direction, while the secondary filter applies taps oriented +/−45° off the primary direction.

The edge detection method in CDEF applies 8 predefined direction patterns. The optimal direction can be determined by minimizing the sum of squared differences between the pixels at the selected locations indicated by directions, and their mean along the directions. In some conventional systems, in CCSO, only one filter shape is allowed and signaled at the frame header for edge direction. This frame level fixed edge direction lack of flexibility within the content of a frame.

A cross-component offset filtering method is an edge preserving loop filter that uses the reconstructed samples to compute the sample offsets of luma and/or chroma components. In some systems, only the luma samples located in positions defined by the filter shape are used to compute the offset of the chroma component or the luma component. The offset indices are signaled at the frame header for each channel. A 1-bit flag is signaled to indicate if the frame level CCSO syntax (ccso_syntax_reuse_flag) reuse is enabled, and a 1-bit indicating if the block level CCSO syntax reuse (ccso_block_reuse_flag) is enabled. If frame and/or block reuse is enabled, we signal a 3-bit reference frame index, named as ccso_ref_idx in Table 1 below.

TABLE 1
Example CCSO Syntax

| | |
|---|---|
| ccso_frame_flag | ae(v) |
| if (ccso_frame_flag) | |
| for plane = 0 to num planes do | |
| ccso_syntax_reuse_flag | ae(v) |
| ccso_block_reuse_flag | ae(v) |
| if (ccso_syntax_reuse_flag \|\| ccso_block_resue_flag) | |
| ccso_ref_idx | ae(v) |
| end for | |

For example, the encoder decides and signals the primary reference frame in the frame header, which decides the initialization value for contexts for current frame or current tile. For derived primary reference frame, primary reference frame is derived at the encoder and the decoder for the current frame/tile (e.g., “A”) based on the frame-level qindex (or qp parameter value), the frame distances, and/or other parameters. For optimal primary reference frames, in the encoder, optimal selection of the primary is further conducted. For each reference, its frame contexts are used as A's starting frame contexts, and A's entropy coding is executed. The resulting coded frame size is recorded. The reference frame with minimum coded frame size is selected as A's optimal primary reference frame. If A's derived primary reference frame is the same as A's optimal primary reference frame, “0” is signaled, otherwise, “1” is signaled in the bitstream. Here, “0” indicates to use the derived primary reference frame, and “1” indicates to use the reference frame signaled later.

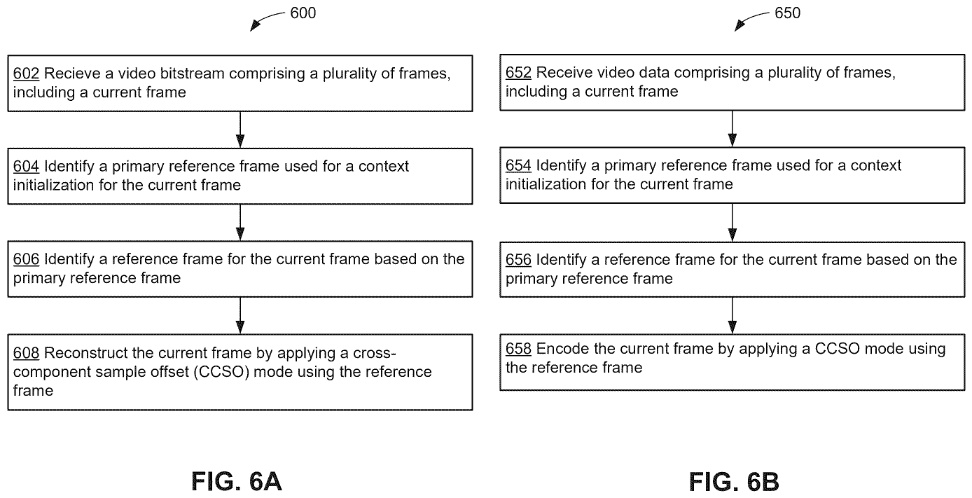

FIG. 6A is a flow diagram illustrating a method 600 of decoding video in accordance with some embodiments. The method 600 may be performed at a computing system (e.g., the server system 112, the source device 102, or the electronic device 120) having control circuitry and memory storing instructions for execution by the control circuitry. In some embodiments, the method 600 is performed by executing instructions stored in the memory (e.g., the memory 314) of the computing system.

The system receives (602) a video bitstream (e.g., a coded video sequence) comprising a plurality of frames (e.g., corresponding to a set of pictures), including a current frame. The system identifies (604) a primary reference frame used for a context initialization for the current frame. The system identifies (606) a reference frame for the current frame based on the primary reference frame. The system reconstructs (608) the current frame by applying a CCSO mode using the reference frame. In this way, signaling of the reference frame index may depend on the primary reference frame or the derived primary reference frame used for frame context initialization.

In some embodiments, a flag, e.g., “ccso_primary_flag”, is used to indicate whether the ccso_ref_idx matches the primary reference frame or derived primary reference frame. For example, a value of 0 is signaled when ccso_ref_idx is the same as the primary reference frame, while a value of 1 is signaled when they differ. In cases where ccso_ref_idx is different from the primary reference frame, the ccso_ref_idx may be explicitly signaled to specify the frame index for CCSO syntax reuse.

TABLE 2
Example CCSO Syntax

| | |
|---|---|
| ccso_frame_flag | ae(v) |
| if (ccso_frame_flag) | |
| for plane = 0 to num planes do | |
| ccso_syntax_reuse_flag | ae(v) |
| ccso_block_reuse_flag | ae(v) |
| if (ccso_syntax_reuse_flag \|\| ccso_block_resue_flag) | |
| ccso_primary_flag | ae(v) |
| if (ccso_primary_flag) | |
| ccso_ref_idx | ae(v) |
| end for | |

In some embodiments, the ccso_ref_idx is not explicit signaled, and the primary reference frame or the derived primary reference frame used for frame context initialization is used as the reference frame for CCSO syntax reuse.

TABLE 3
Example CCSO Syntax

| | |
|---|---|
| ccso_frame_flag | ae(v) |
| if (ccso_frame_flag) | |
| for plane = 0 to num planes do | |
| ccso_syntax_reuse_flag | ae(v) |
| ccso_block_reuse_flag | ae(v) |
| if (ccso_syntax_reuse_flag \|\| ccso_block_resue_flag) | |
| ccso_ref_idx = priamry reference frame | |
| end for | |

In some embodiments, the ccso_ref_idx is implicit derived based on the frame level qindex (or qp parameter value) and the frame distances and other possible parameters.

In some embodiments, only a subset of the reference frames in the reference frame buffer may be used or signaled when cross component sample offset is reusing the syntaxes from previously decoded frames.

In some embodiments, only the derived primary reference frame and derived secondary reference frames can be used for syntax reuse, and one flag may be signaled into the bitstream to indicate which of these two reference frames are used for CCSO syntax reuse.

TABLE 4
Example CCSO Syntax

| | |
|---|---|
| ccso_frame_flag | ae(v) |
| if (ccso_frame_flag) | |
| for plane = 0 to num planes do | |
| ccso_syntax_reuse_flag | ae(v) |
| ccso_block_resue_flag | ae(v) |
| if (ccso_syntax_reuse_flag \|\| ccso_block_resue_flag) | |
| ccso_primary_flag | ae(v) |
| end for | |

In some embodiments, only the reference frames from the same temporal level or lower temporal level can be used for syntax reuse. In some embodiments, a high-level syntax is signaled to indicate the switch between the various implementations described above. In some embodiments, the CCSO syntax reuse mode is not allowed when error resilience mode is enabled.

In some embodiments, a “ccso_syntax_reuse_flag” and/or a “ccso_block_resue_flag” is shared by all the channels, e.g., the Y, U, and V channels. In some embodiments, the Y channel has its own flags for “ccso_syntax_reuse_flag” and/or the “ccso_block_resue_flag”, and the U and V channels share the two flags.

FIG. 6B is a flow diagram illustrating a method 650 of encoding video in accordance with some embodiments. The method 650 may be performed at a computing system (e.g., the server system 112, the source device 102, or the electronic device 120) having control circuitry and memory storing instructions for execution by the control circuitry. In some embodiments, the method 650 is performed by executing instructions stored in the memory (e.g., the memory 314) of the computing system. In some embodiments, the method 650 is performed by a same system as the method 600 described above.

The system receives (652) video data (e.g., source video sequence) comprising a plurality of frames (e.g., corresponding to a set of pictures), including a current frame. The system identifies (654) a primary reference frame used for a context initialization for the current frame. The system identifies (646) a reference frame for the current frame based on the primary reference frame. The system encodes (648) the current frame by applying a CCSO mode using the reference frame. As described previously, the encoding process may mirror the decoding processes described herein (e.g., loop filtering, such as cross-component offset filtering). For brevity, those details are not repeated here.

Although FIGS. 6A and 6B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.
(A1) In one aspect, some embodiments include a method (e.g., the method 600) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of frames (e.g., corresponding to a set of pictures), including a current frame; (ii) identifying a primary reference frame used for a context initialization for the current frame; (iii) identifying a reference frame for the current frame based on the primary reference frame; and (iv) reconstructing the current frame by applying a cross-component sample offset (CCSO) mode using the reference frame. In this way, signaling of the reference frame index may depend on the primary reference frame or the derived primary reference frame used for frame context initialization.
(A2) In some embodiments of A1, the method further comprises applying CCSO mode to the current frame using one or more CCSO syntax from the reference frame. For example, when the frame level or block level cross component sample offset syntax is reusing the syntax from the reference frames, the reference frame index can be implicitly derived or explicitly signaled.
(A3) In some embodiments of A1 or A2, identifying the reference frame comprises parsing an indicator from the video bitstream, the indicator indicating whether the reference frame is the primary reference frame. For example, a flag, “ccso_primary_flag”, is used to indicate whether the ccso_ref_idx matches the primary reference frame or derived primary reference frame. A value of 0 is signaled when ccso_ref_idx is the same as the primary reference frame, while a value of 1 is signaled when they differ. In cases where ccso_ref_idx is different from the primary reference frame, the ccso_ref_idx may be explicitly signaled to specify the frame index for CCSO syntax reuse.
(A4) In some embodiments of any of A1-A3, identifying the reference frame comprises: (i) when the video bitstream includes an indicator, selecting the reference frame indicated by the indicator; and (ii) when the video bitstream does not include the indicator, selecting the primary reference frame as the reference frame. For example, when the ccso_ref_idx is not explicitly signaled, the primary reference frame or the derived primary reference frame used for frame context initialization may be served as the reference frame for CCSO syntax reuse.
(A5) In some embodiments of any of A1-A4, the primary reference frame is a derived primary reference frame. In some embodiments, the primary reference frame is a signaled primary reference frame.
(A6) In some embodiments of any of A1-A5, reconstructing the current frame using the reference frame comprises applying a CCSO mode to the current frame, the CCSO mode using one or more parameters from the reference frame. In some embodiments, a “ccso_syntax_reuse_flag” and/or a “ccso_block_resue_flag” is shared by multiple color channels, e.g., the Y, U, and V channels. As an example, the Y channel may have its own flags for “ccso_syntax_reuse_flag” and/or the “ccso_block_resue_flag”, and the U and V channels may share the two flags. Sharing flags across multiple color components reduces signaling overhead for the video bitstream.
(A7) In some embodiments of any of A1-A6, the reference frame is identified based on one or more frame-level parameters of the current frame. For example, the ccso_ref_idx may be implicitly derived based on the frame level qindex (or qp parameter value) and the frame distances and other possible parameters.
(A8) In some embodiments of any of A1-A7, the reference frame is selected from a reference frame buffer.
(A9) In some embodiments of A8, the reference frame is selectable from only a subset of reference frames in the reference frame buffer. As an example, only a subset of the reference frames in the reference frame buffer may be used or signaled when cross component sample offset is reusing the syntaxes from previously decoded frames. For example, only the reference frames from the same temporal level or lower temporal level as compared to the current frame can be used for syntax reuse.
(A10) In some embodiments of A9, the subset of the reference frames in the reference frame buffer consists of primary and secondary reference frames. For example, only the derived primary reference frame and derived secondary reference frames can be used for syntax reuse, and one flag may be signaled into the bitstream to indicate which of these two reference frames are used for CCSO syntax reuse. Using only a subset of the reference frames allows for less signaling bits (e.g., a reduced index range to signal), which reduces signaling overhead for the bitstream.
(A11) In some embodiments of any of A1-A10, the method further comprises parsing an indicator from the video bitstream, the indicator indicating how to identify the reference frame for the current frame. For example, a high-level syntax may be signaled to indicate the switch between embodiments described above. In some embodiments, the CCSO syntax reuse mode is not allowed when an error resilience mode is enabled.
(B1) In another aspect, some embodiments include a method (e.g., the method 650) of video encoding. In some embodiments, the method is performed at a computing system (e.g., the server system 112) having memory and control circuitry. In some embodiments, the method is performed at a coding module (e.g., the coding module 320). The method includes: (i) receiving video data (e.g., a source video sequence) comprising a plurality of frames (e.g., corresponding to a set of pictures), including a current frame; (ii) identifying a primary reference frame used for a context initialization for the current frame; (iii) identifying a reference frame for the current frame based on the primary reference frame; and (iv) encoding the current frame by applying a CCSO mode using the reference frame. In some embodiments, the method further includes signaling coded information for the current frame.
(B2) In some embodiments of B1, the CCSO mode is applied using one or more parameters from the reference frame.
(B3) In some embodiments of B1 or B2, the method further comprises signaling an indicator indicating whether the reference frame is the primary reference frame.
(B4) In some embodiments of any of B1-B3, the method further comprises: (i) when the reference frame is not the primary reference frame, signaling an indicator for the reference frame in a video bitstream; and (ii) when the reference frame is the primary reference frame, forgoing signaling the indicator.
(B5) In some embodiments of any of B1-B4, the reference frame is identified based on one or more frame-level parameters of the current frame.
(B6) In some embodiments of any of B1-B5, the reference frame is selected from a reference frame buffer.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A11 and B1-B6 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A11 and B1-B6 above). In some embodiments, a memory or non-transitory computer-readable storage medium stores a video bitstream including any of the features (e.g., syntax and encoded information) disclosed herein.

Unless otherwise specified, any of the syntax elements described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/of” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of frames, including a current frame;
identifying a primary reference frame used for a context initialization for the current frame;
identifying a reference frame for the current frame based on the primary reference frame; and
reconstructing the current frame by applying a cross-component sample offset (CCSO) mode using the reference frame.

2. The method of claim 1, further comprising applying CCSO mode to the current frame using one or more CCSO syntax from the reference frame.

3. The method of claim 1, wherein identifying the reference frame comprises parsing an indicator from the video bitstream, the indicator indicating whether the reference frame is the primary reference frame.

4. The method of claim 1, wherein identifying the reference frame comprises:
when the video bitstream includes an indicator, selecting the reference frame indicated by the indicator; and
when the video bitstream does not include the indicator, selecting the primary reference frame as the reference frame.

5. The method of claim 1, wherein the primary reference frame is a derived primary reference frame.

6. The method of claim 1, wherein reconstructing the current frame using the reference frame comprises applying a CCSO mode to the current frame, the CCSO mode using one or more parameters from the reference frame.

7. The method of claim 1, wherein the reference frame is identified based on one or more frame-level parameters of the current frame.

8. The method of claim 1, wherein the reference frame is selected from a reference frame buffer.

9. The method of claim 8, wherein the reference frame is selectable from only a subset of reference frames in the reference frame buffer.

10. The method of claim 9, wherein the subset of the reference frames in the reference frame buffer consists of primary and secondary reference frames.

11. The method of claim 1, further comprising parsing an indicator from the video bitstream, the indicator indicating how to identify the reference frame for the current frame.

12. A method of video encoding performed at a computing system having memory and one or more processors, the method comprising:
receiving video data comprising a plurality of frames, including a current frame;
identifying a primary reference frame used for a context initialization for the current frame;
identifying a reference frame for the current frame based on the primary reference frame; and
encoding the current frame by applying a CCSO mode using the reference frame.

13. The method of claim 12, wherein the CCSO mode is applied using one or more parameters from the reference frame.

14. The method of claim 12, further comprising signaling an indicator indicating whether the reference frame is the primary reference frame.

15. The method of claim 12, further comprising:
when the reference frame is not the primary reference frame, signaling an indicator for the reference frame in a video bitstream; and
when the reference frame is the primary reference frame, forgoing signaling the indicator.

16. The method of claim 12, wherein the reference frame is identified based on one or more frame-level parameters of the current frame.

17. The method of claim 12, wherein the reference frame is selected from a reference frame buffer.

18. A non-transitory computer-readable storage medium storing a video bitstream that is generated by a video encoding method, the video bitstream comprising:
coded information for a plurality of frames of video data, including a current frame; and
wherein the video encoding method comprises:
identifying a primary reference frame used for a context initialization for the current frame;
identifying a reference frame for the current frame based on the primary reference frame; and
encoding the current frame by applying a CCSO mode using the reference frame.

19. The non-transitory computer-readable storage medium of claim 18, wherein the video bitstream further comprises an indicator indicating whether the reference frame is the primary reference frame.

20. The non-transitory computer-readable storage medium of claim 18, wherein the CCSO mode uses one or more parameters from the reference frame.
